(19) United States
(12) Patent Application Publication
(10) Pub. No.: US 2019/0089619 A1
(43) Pub. Date: Mar. 21, 2019

(54) SELF-TEST ENGINE FOR NETWORK ON CHIP

(71) Applicant: QUALCOMM Incorporated, San Diego, CA (US)

(72) Inventors: Hans YEAGER, Chapel Hill, NC (US); Scott LEMKE, Cary, NC (US); Thomas BASNIGHT, Raleigh, NC (US); Zainab Nasreen ZAIDI, Raleigh, NC (US)

(73) Assignee: QUALCOMM Incorporated, San Diego, CA (US)

(21) Appl. No.: 15/711,603

(22) Filed: Sep. 21, 2017

(51) Int. Cl. H04L 12/26

(52) U.S. Cl. CPC H04L 43/50; H04L 49/15

(57) ABSTRACT

Aspects of the present disclosure propose techniques for testing a network on chip (NoC). An exemplary method may generally include generating, at a source node of the NoC, a first plurality of packets according to a first pre-defined pattern of a plurality of pre-defined patterns, wherein each pre-defined pattern is designed to provoke transients in the NoC, generating, at the source node of the NoC, a second plurality of packets according to the first pre-defined pattern of the plurality of pre-defined patterns, generating the transients in the NoC by transmitting the first plurality of packets and thereafter transmitting the second plurality of packets, and verifying at least one of the first plurality of packets or the second plurality of packets are successfully received at a destination node of the NoC despite the generated transients.

### TECHNICAL FIELD

The teachings of the present disclosure relate generally to network-on-chips (NoCs), and more particularly, to a self-test engine for NoCs.

### INTRODUCTION

Computing devices are ubiquitous. Some computing devices are portable such as mobile phones, tablets, and laptop computers. As the functionality of such portable computing devices increases, the computing or processing power required and generally the data storage capacity to support such functionality also increases. In addition to the primary function of these devices, many include elements that support peripheral functions. For example, a cellular telephone may include the primary function of enabling and supporting cellular telephone calls and the peripheral functions of a still camera, a video camera, global positioning system (GPS) navigation, web browsing, sending and receiving emails, sending and receiving text messages, push-to-talk capabilities, etc. Many of these portable devices include a system-on-chip (SoC) to enable one or more primary and peripheral functions on the specific device.

The number of components on a chip is rapidly growing due to increasing levels of integration, system complexity and shrinking transistor geometry. Complex SoCs may comprise various components such as processor cores, digital signal processors (DSPs), hardware accelerators, memory and I/O. In SoC systems, the on-chip interconnect between on-chip components plays a role in providing high-performance communication between the various components. Due to scalability limitations of traditional buses and crossbar based interconnects, Network-on-Chip (NoC) has emerged as a paradigm to interconnect a large number of components on the chip. NoC is a global shared communication infrastructure made up of several routing nodes interconnected with each other using point-to-point physical links, which apply networking theory to on-chip communication.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some aspects, the present disclosure provides a method for testing a network on chip (NoC). The method includes generating, at a source node of the NoC, a first plurality of packets according to a first pre-defined pattern of a plurality of pre-defined patterns, wherein each pre-defined pattern is designed to provoke transients in the NoC, generating, at the source node of the NoC, a second plurality of packets according to the first pre-defined pattern of the plurality of pre-defined patterns, generating the transients in the NoC by transmitting the first plurality of packets and thereafter transmitting the second plurality of packets, and verifying at least one of the first plurality of packets or the second plurality of packets are successfully received at a destination node of the NoC despite the generated transients.

In some aspects, the present disclosure provides a circuit. The circuit includes means for means for generating, at a source node of the NoC, a first plurality of packets according to a first pre-defined pattern of a plurality of pre-defined patterns, wherein each pre-defined pattern is designed to provoke transients in the NoC, means for generating, at the source node of the NoC, a second plurality of packets according to the first pre-defined pattern of the plurality of pre-defined patterns, means for generating the transients in the NoC by transmitting the first plurality of packets and thereafter transmitting the second plurality of packets, and means for verifying at least one of the first plurality of packets or the second plurality of packets are successfully received at a destination node of the NoC despite the generated transients.

In some aspects, the present disclosure provides a computer readable medium having instructions stored thereon for causing a circuit to perform a method for testing a network on chip (NoC). The method includes generating, at a source node of the NoC, a first plurality of packets according to a first pre-defined pattern of a plurality of pre-defined patterns, wherein each pre-defined pattern is designed to provoke transients in the NoC, generating, at the source node of the NoC, a second plurality of packets according to the first pre-defined pattern of the plurality of pre-defined patterns, generating the transients in the NoC by transmitting the first plurality of packets and thereafter transmitting the second plurality of packets, and verifying at least one of the first plurality of packets or the second plurality of packets are successfully received at a destination node of the NoC despite the generated transients.

In some aspects, the present disclosure provides a circuit. The circuit includes a network on chip (NoC). The NoC is configured to generate, at a source node of the NoC, a first plurality of packets according to a first pre-defined pattern of a plurality of pre-defined patterns, wherein each pre-defined pattern is designed to provoke transients in the NoC, generate, at the source node of the NoC, a second plurality of packets according to the first pre-defined pattern of the plurality of pre-defined patterns, generate the transients in the NoC by transmitting the first plurality of packets and thereafter transmitting the second plurality of packets, and verify at least one of the first plurality of packets or the second plurality of packets are successfully received at a destination node of the NoC despite the generated transients.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example network-on-chip (NoC) ring topology, in accordance with certain aspects of the present disclosure.

FIG. 2 illustrates an example network-on-chip (NoC) mesh topology, in accordance with certain aspects of the present disclosure.

FIG. 3 is a schematic diagram of an network-on-chip node that includes a traffic generator/comparator configured to generate and verify traffic in the network-on-chip, according to aspects of the present disclosure.

FIG. 4 illustrates information stored in a content status register (CSR) included within data generators/comparators in a network on chip, according to aspects of the present disclosure.

FIG. 5 illustrates example operations for testing a network on chip, according to certain aspects of the present disclosure.

FIG. 6 is a call flow diagram illustrating a process for testing a network on chip, according to certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Although the teachings of this disclosure are illustrated in terms of integrated circuits (e.g., a network-on-chip (NoC)), the teachings are applicable in other areas. The teachings disclosed should not be construed to be limited to NoC designs or the illustrated embodiments. The illustrated embodiments are merely vehicles to describe and illustrate examples of the inventive teachings disclosed herein.

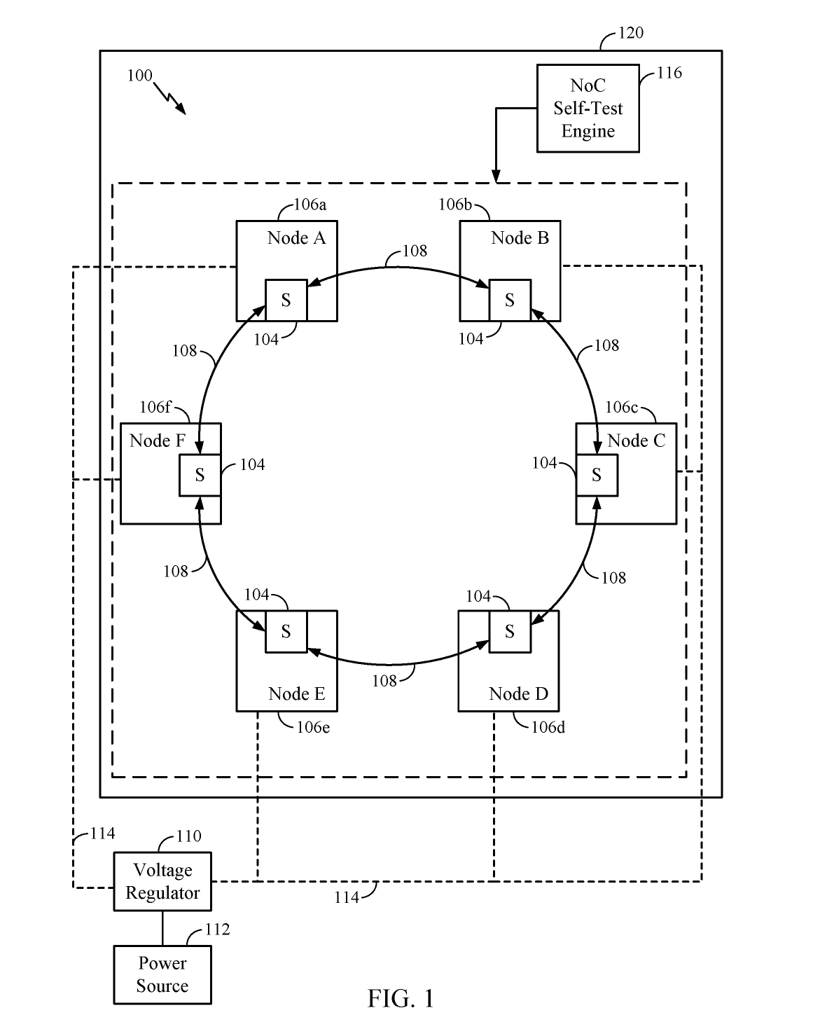

Aspects of the present disclosure propose techniques for testing networks-on-chips (NoCs). An NoC may be configured to provide communication capability between various components that reside in a system on chip (SoC). FIG. 1 is a schematic diagram of an embodiment of a system-on-chip (SoC) 120 that may be included in a device 100. As illustrated, SoC 120 comprises an NoC 102 including a plurality of switches 104 interconnecting a corresponding plurality of nodes 106a-106d. Nodes 106a-106d provide various functionalities, such as information processing. In some cases, nodes 106a-106d may comprise a digital signal processor (DSP) core or a CPU core. In other cases, nodes 106a-106d may comprise random logic blocks, custom signal (audio or video) signal processing blocks, RF front-end, on-chip memory, and/or various controllers.

The NoC 102 may be configured to provide communications capability between nodes 106a-106d using switches 104 and communication links 108. While FIG. 1 illustrates only four nodes (e.g., 106a-106d), it should be understood that an NoC 102 may connect any number and/or type of nodes 106a-106d. Additionally, although FIG. 1 shows four switches 104, an NoC 102 may comprise any number of switches 104 and communication links 108.

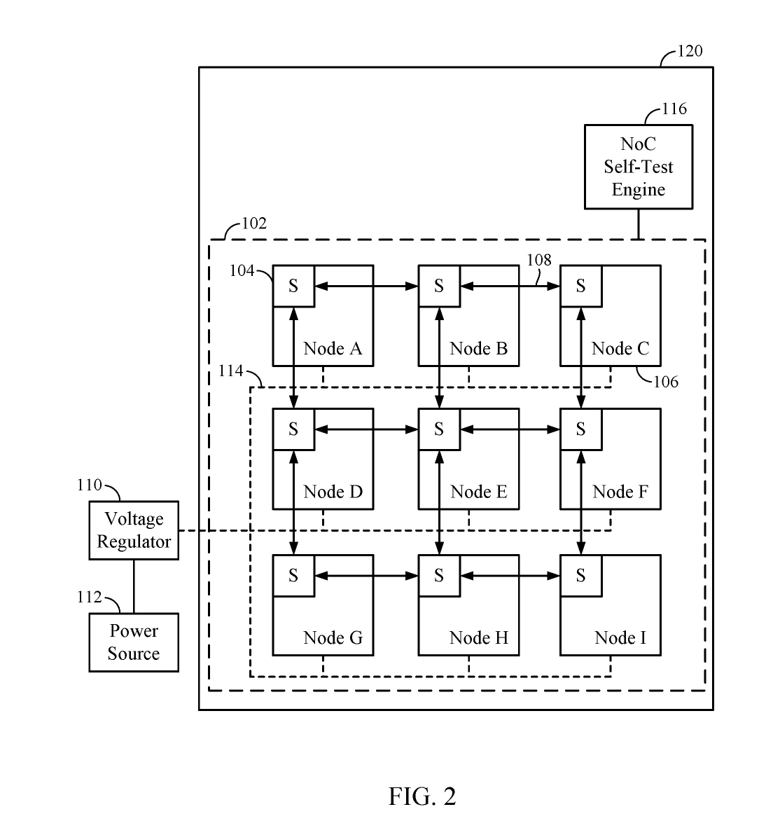

The NoC 102 may be configured according to various topologies depending on a particular operating need. For example, in some cases, as illustrated in FIG. 1, switches 104 and communication links 108 may be arranged according to a ring topology, known as a ring network, where each switch 104 may connect to only two other switches. In other cases, for example, as illustrated in FIG. 2, switches 104 and communication links 108 may be arranged according to a mesh topology, known as a mesh network, where each switch 104 may be directly connected to two or more other switches.

The communication links 108 may be any such devices that are capable of carrying segmented bits of information, known as transactions, between switches 104 and/or nodes 106. For example, in some cases, the communication links 108 may be hard wire links, whereas in other cases, the communication links may be optical or wireless links.

The switches 104 may be any devices that promote routing of transactions within the NoC 102. For example, in some cases, switches 104 may include a processor that is in communication with a memory (e.g., a read only memory (ROM), a random access memory (RAM), or any other type of memory) and configured to route transactions within the NoC 102.

Switches 104 may be configured to segment an incoming packet (e.g. an Internet Protocol (IP) packet, an Ethernet frame, a DDR access of memory, a cache line of memory, or generally all data and communication transfers between components on a SoC) into units of information known as flow control digits, for example, if not already performed by one of nodes 106a-106d. Further, switches 104 may also be configured to reassemble the transactions into an outgoing packet. Additionally, switches 104 may be configured to perform transaction and/or packet routing by receiving transactions/packets and determine which of a plurality of virtual channels (e.g., corresponding to time/frequency resources on a communication link 108) on which to transmit the transactions/packets and/or which of a plurality of routes on which to transmit the transactions/packets. It should be noted that switches 104 may comprise one or more processors, coupled with a memory, configured to perform techniques presented herein.

As discussed above, transactions may be formed by segmenting packets (e.g., IP packets or Ethernet frames) that enter the NoC 102. A transaction that enters an NoC 102 may be referred to as being injected into an NoC 102, for example, by one of the nodes 106a-106d. For example, in some cases, a node 106a may segment a packet into a plurality of transactions and inject the transactions into the NoC 102 by transmitting the plurality of transactions to the switch 104 corresponding to node 106a. It should be noted that a switch in which a transaction enters the NoC 102 may be referred to as a source or source switch, and a switch where a transaction exits the NoC 102 may be referred to as a destination or destination switch.

As illustrated in FIG. 1, the device 100 also includes a power source 112 used to provide a supply voltage to each node 106 in the SoC 120 via a power delivery network (PDN) 114. In order to prevent circuit malfunction, a voltage regulator 110 may be used to regulate the voltage supplied to the nodes 106 from power source 112. For example, voltage regulator 110 may be used to provide a substantially constant DC output voltage to nodes 106 regardless of changes in load current or input voltage. While only one voltage regulator is illustrated in FIG. 1, it should be understood that the device 100 may include multiple voltage regulators configured to regulate the voltage supplied to different components in the SoC 120. For example, in some cases, each node 106a-106d may be associated with its own voltage regulator.

Large NoCs can consume significant amounts of power. For example, dynamic power (e.g., power that is used dynamically by the NoC) is proportional to an activity factor (AF) equal to C*F*(V̂2), where C is the total capacitance of the NoC, F is the operating frequency of the NoC, and V is the operating voltage of the NoC. For large NoC, the capacitance of the wires and associated buffers during data transfer can rise to significant value, especially when the NoC is operated at several gigahertz (GHz), resulting in significant power consumption.

Additionally, due to a large number of wires (e.g., the width of a communication link 108) needing to be used to transmit a packet in the NoC (and each of these wires' associated capacitance), the activity factor is heavily dependent on changes in data patterns transmitted on these wires/communication links 108. For example, if there is high traffic in the NoC 102, but all of the data being transmitted is constant (e.g., say all zeros), the activity factor associated with the wires used to move the data is approximately zero, neglecting some small number of wires associated with the changes of address or command. However, if the wires within a communication link 108 are changing every clock cycle (e.g., say from all zeros to all ones or an interleaved patterns between 0xAAAAAAAA and 0x55555555) the activity factor can more than double that of the all zeros case with the exact same number of transaction in both cases.

As noted above, the device 100 includes a PDN 114 used to supply energy from a voltage regulator 110 to the circuits of the NoC 102. In some cases, during data transmission in the NoC 102, PDN 114 may experience voltage transients, associated with changes in current consumption in the SoC 120, due to the various LRC components of PDN 114 from the base layers of the silicon die of the SoC 120 (e.g., where transistors consume energy (e.g., a current sink)) to the voltage regulator 110.

The voltage regulator 110 may be on-die or off-die (e.g., as illustrated in FIG. 1), but each configuration has its own LRC-network and response-time characteristics and both still need to be able to manage voltage droops associated with fast changes in current consumption (e.g., due to traffic patterns transmitted in the NoC 102). For example, as current consumption increases in the SoC 120, the voltage in the PDN 114 droops due to the voltage transients until the voltage regulator 110 can respond by increasing the current being supplied to the PDN 114. Thus, a voltage set-point at the voltage regulator 110 must be maintained high enough that this voltage set-point minus the magnitude of the voltage droop, due to a transient event, is still high enough to avoid a circuit failure.

According to aspects, most, if not all, circuits on a PDN have this voltage droop issue to contend with, but most circuits have a fairly significant amount of control logic and/or other architectural features that tend to increase the amount of time it takes to make significant changes in current consumption. For example, a CPU may take several cycles from the start of instruction fetch until the pipeline is full and the other components of the CPU are activated. Furthermore, once most of the CPU components are busy, it is difficult to keep all of the wires in the CPU's data paths toggling every cycle. In contrast, this toggling issue is much easier to do in the case of a NoC structure.

For example, for NoCs running well above 1 GHz, the current consumption can change with data dependency, which can happen in a single cycle. This is exasperated by the fact that an NoC usually has several master nodes (CPUs, or other clients) that can all start accessing the NoC simultaneously or could all start changing their data patterns simultaneously. Thus, in just a couple of cycles (e.g., associated with multiple hops between switches in the NoC) the current consumption of the entire NoC can more than double. This may amount to transient currents in the PDN 114 on the order of 25 amps per-nanosecond, creating a difficult constraint on the PDN design.

Thus, aspects of the present disclosure propose techniques for rapidly ensuring that circuits in an NoC (e.g., NoC 102) will not experience a failure in the presence of voltage droops in the NoC's power delivery network. For example, aspects of the present disclosure propose techniques for instructing nodes in the NoC to create worst-case transient current conditions in the power delivery network (that lead to the worst voltage droops) and test the communication channels (e.g., communication links 108) despite the transients.

In some cases, this may involve instructing source nodes to send specific pre-known data patterns (e.g., designed to generate the transients) and destination nodes to check that the data is received correctly. For example, aspects of the present disclosure propose including a traffic/data generator (e.g., in switches 104) at each point in the NoC where traffic may be injected. The traffic generator may be configured (e.g., by the self-test engine 116) to generate traffic according to any one of a plurality of pre-defined data patterns designed to induce transients within the NoC's power delivery network. Aspects of the present disclosure also propose including traffic/data comparators (e.g., in switches 104) at each point in the NoC where traffic may be injected. The traffic comparators may be configured (e.g., by the self-test engine 116) to verify that traffic transmitted on the NoC is being received correctly despite the induced transients.

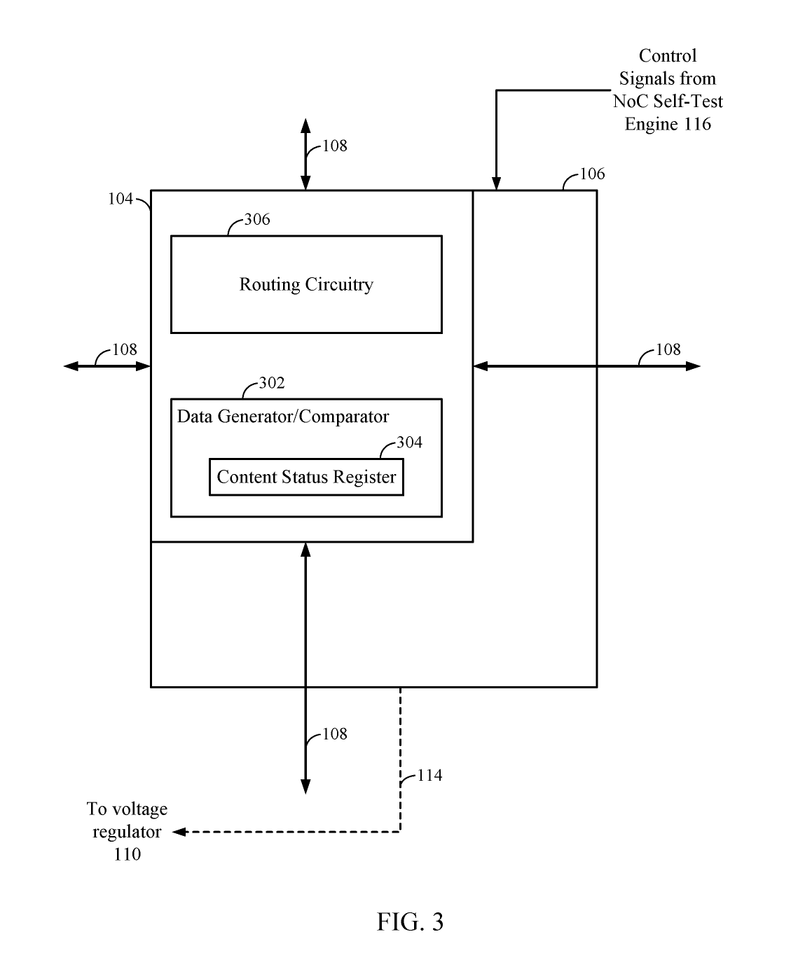

FIG. 3 is a schematic diagram of an NoC node (e.g., node 106) that includes a traffic generator/comparator configured to generate and verify traffic in the NoC, according to aspects of the present disclosure. According to aspects, the NoC node illustrated in FIG. 3 may be an example of a node included within the ring topology illustrated in FIG. 1 or the mesh topology illustrated in FIG. 2.

As illustrated, switch 104, corresponding to node 106, may include a data generator/comparator 302 for generating and verifying traffic transmitted in the NoC. Switch 104 may also include routing circuitry 306 for determining where in the NoC to route received traffic (e.g., whether it be to the switch's corresponding node or to another node in the NoC).

As noted, for testing purposes, the data generator/comparator 302 may be configured (e.g., by the self-test engine 116) to create transient conditions in the PDN 114 that lead to the significant voltage droops in the PDN 114. According to aspects, the data generator/comparator 302 may create/generate these transients by generating packets according to one or more pre-defined patterns that are designed to provoke different transients in the PDN 114 of the NoC 102 and transmitting the packets in the NoC 102. In some cases, the transients may be generated between the transmissions of packets (e.g., generated according to different pre-defined patterns) in the NoC 102. According to aspects, the pre-defined patterns may be stored in a control status register (CSR) 304 of the data generator/comparator 302 and may be selected by the data generator/comparator 302 depending on a type of transient condition to be tested.

According to aspects, a first pre-defined pattern may be known as an “all-zeros” pattern and may involve setting all of the data bits in one or more packets to zero. For example, the data generator/comparator 302 may generate one or more packets with data bits all set to zero and transmit these packets from a source node (e.g., that includes the data generator/comparator 302) to a destination node in the NoC 102. According to aspects, this “all-zero” pre-defined pattern may be used by the data generator/comparator to create a quiescent low power state in the NoC 102.

A second pre-defined pattern may be known as an “all-ones” pattern and involve setting all of the data bits in the one or more packets to ones. The “all-ones” pattern may be used to create a quiescent lower power state in the NoC 102.

A third pre-defined pattern, known as a “checkerboard” pattern, may involve setting all nibbles of data in a first packet of the one or more packets to 0xA and thereafter setting all the nibbles of data in a second packet of the one or more packets to 0x5 on a next clock cycle of the NoC 102. For example, using the “checkerboard” pattern, the generator/comparator 302 may generate a first packet and set each nibble of data (e.g., every four bits of data) in the packet to 0xA and transmit this packet to a destination node in the NoC 102. On the next clock cycle, the generator/comparator 302 may generate a second packet and set each nibble in the second packet to 0x5 and transmit the second packet to the destination node in the NoC 102. According to aspects, the “checkerboard” pattern induces a maximum number of edges to toggle cycle-by-cycle and stresses parasitic capacitance between wires in the communication link on which these packets are sent. Additionally, the “checkerboard” pattern typically induces higher power consumption in the PDN 114 than the “all-zeros” and “all-ones” pre-defined patterns. In some cases, a “double checkerboard” pattern may be used, where nibbles of data of a first packet of the one or more packets are set to 0xC and nibbles of data of a second packet of the one or more packets are set to 0x3.

A fourth pre-defined pattern may comprise a randomly generated data pattern. For example, in some cases, the data generator/comparator 302 may generate one or more packets with randomly set data bits, for example, according to a pseudorandom binary sequence (e.g., PRBS7) or any other suitable random pattern of bits. In some cases, the random data pattern may be designed so as to approximate functional traffic in the NoC 102.

A fifth pre-defined pattern, known as a “virus” pattern, may be based on the specific architecture of the NoC 102 and designed to exploit a maximum-toggling and worst-case power consumption scenario in the NoC 102, taking into account any data power reducing schemes or wire routing topologies in the NoC 102. For example, in a data bit inversion scheme where greater than n/2 bits change in a cycle, results in that cycle's data being inverted and an extra control bit added that indicates the data was inverted. Accordingly, this “virus” pattern may be configured to change n/2 bits cycle by cycle, resulting in a maximum number of wires in a communication link 108 toggling cycle by cycle and leading to a worst-case power consumption scenario.

According to aspects, when generating packets according to one or more of the pre-defined patterns, the data generator/comparator 302 may treat as many bits of the communication link 108 (e.g., over which the packets are transmitted) as possible as a bulk payload. For example, when generating the packets, the data generator/comparator 302 may treat parity bits and/or error correcting code (ECC) bits as regular data and may extend the pre-defined patterns to cover these bits.

According to aspects, after generating the packets according to a pre-defined pattern, the data generator/comparator 302 may generate the transients in the NoC 102 (e.g., the PDN 114 of the NoC 102) by transmitting these packets in the NoC 102. According to aspects, as noted above, the transients may be generated between transmissions of packets generated according to differing pre-defined patterns. For example, assume at time t0 no packets designed to test the NoC 102 are being transmitted and that at time t1 first plurality of packets generated according to a first pre-defined pattern are transmitted in the NoC 102. According to aspects, upon transmitting the packets, the packets may begin to cause stresses in the PDN 114 of the NoC 102 (e.g., current consumption associated with nodes in the NoC 102 will rise), which give rise to transients (e.g., large spikes in current in the PDN 114). Additionally, at time t2 when a second plurality of packets, generated according to a second pre-defined pattern, are transmitted in the NoC 102, these the second plurality of packets may begin to cause a different type of transient in the PDN 114 than the transient caused by the packets transmitted at t1. According to aspects, generating and transmitting packets according to differing pre-defined patterns and the ability to change the amount of time each plurality of packets is sent for (described below), may allow time-constants associated with the LRC (e.g., Inductor, Resistor, Capacitor) natures of the PDN 114 to be fully tested.

Once the transients have been generated in the NoC 102, the data generator/comparator 302 may then verify that all packets transmitted in the NoC 102 were received correctly despite the transients, which will be described in greater detail below. Verifying whether packets are received correctly at a destination node despite the transients may be used to determine whether the PDN 114 is adequately supporting the NoC 102 without causing circuit failures.

According to aspects, the data generator/comparator 302 may generate packets according to the pre-defined patterns in a particular order or sequence. For example, the data generator/comparator 302 may determine (e.g., based on a pre-programmed pattern select and sequence field in the CSR 304) to generate and transmit packets according to a first pre-defined pattern repeatedly for a programmable number of times before switching to generating and transmitting packets according to a second pre-defined pattern. For example, a count may be provided for each pre-defined pattern that indicates a maximum value that is large enough such that such that packets generated according to that pre-defined pattern has enough time to traverse the NoC 102 from the source node transmitting the packets to the packets' destination node. According to aspects, the patterns to sequence and the length of each pattern (i.e., the count or number of times to repeatedly transmit packets generated according to the patterns) may be configured using the CSR 304 in the data generator/comparator 302. In some cases, the pattern or pattern sequence may run continuously (i.e., the data generator/comparator 302 continuously generates and transmits packets according to a pre-defined pattern) without requiring programming to maintain the pattern generation.

In some cases, the CSR 304 in the data generator/comparator 302 may be used to set a fixed destination node (e.g., an address of the destination node) to which the packets generated according to the pre-defined pattern are sent to by the data generator/comparator 302. For example, the CSR 304 may contain an address of a destination node to which packets should be transmitted. When generating packets according to a pre-defined pattern, the data generator/comparator 302 may determine the address of the destination node for the packets from the CSR 304 and use the routing circuitry 306 to transmit/rout the packets to the destination node. For example, the data generator/comparator 302 may include the address of the destination node in the packets. The packets may be passed onto the routing circuitry 306, which may thereafter route the packets to the destination node based on the address included within the packets.

In some cases, depending on how the destination nodes are configured in the CSR 304 and which data generators/comparators are enabled in the NoC 102, different traffic densities may be directed to different regions in the NoC 102. For example, multiple data generators/comparators 302 (e.g., in different nodes in the NoC 102) may be configured to generate and transmit traffic to a particular region or node in the NoC 102, inducing a larger traffic density in this region of the NoC 102. Directing traffic to specific regions of the NoC 102 allows these regions to be tested to determine whether the PDN 114 can adequately support these regions of the NoC 102 without causing circuit failures.

According to aspects, in some cases, the number of packets generated according to a pre-defined pattern at each data generator/comparator 302 may be controlled by a throttle control. For example, the throttle control may be a programmable interval between when packets are transmitted and/or a programmable interval range with a random interval between each packet chooses from within the range. For example, in some cases, at time t, the data generator/comparator 302 may generate and transmit a first packet or packet sequence. The data generator/comparator 302 may then wait an interval i (e.g., based on the programmed throttle control) and generate and transmit a second packet or packet sequence at time t+i. According to aspects, both the throttle control value and the throttle range value may be stored in the CSR 304 accessed by the data generator/comparator 302.

In some cases, triggers may be used in the NoC 102 to start and stop packet generation by the data generator/comparator 302. For example, in some cases, each data generator/comparator 302 may be configured to respond to a start trigger command and a stop trigger command broadcast in the NoC 102. In some cases, the trigger command may comprise a cross-trigger event stored in a cross-trigger matrix. According to aspects, when a trigger mode is enabled on the data generator/comparator 302 (e.g., the CSR 304 comprises an indication that the trigger mode is enabled), the data generator/comparator 302 may wait for a “start” command broadcast in the NoC 102 by the self-test engine 116 before generating packets according to a pre-defined pattern designed to create transients in the NoC 102 and transmitting these packets.

According to aspects, once the “start” command is received by the data generator/comparator 302, the data generator/comparator 302 may start a trigger delay counter and wait until the trigger delay counter reaches a pre-programmed “start_delay” value stored in the CSR 304 to begin generating and sending the packets. Likewise, once a “stop” command is received (e.g., from the self-test engine 116) while generating packets according to the pre-defined patterns, the data generator/comparator 302 may wait start the trigger delay counter and wait until the trigger delay counter reaches a pre-programmed “stop_delay” value stored in the CSR 304 to terminate generating and transmitting the data packets.

According to aspects, by incorporating a start delay on the start trigger, each data generator/comparator 302 in the NoC 102 can be programmed to start sending data packets at the same time (e.g., within a couple cycles) regardless of when the “start” command was received from the self-test engine 116. For example, data generators/comparators that have a longer trigger command latency may have a shorter “start_delay” programmed. For instance, if a broadcast command takes 10 cycles to get to data generator/comparator A and 6 cycles to get to data generator/comparator B, the start_delay for data generator/comparator B may be programmed to be 4 cycles greater than the start_delay for generator/comparator A to start generating data at the same time.

Additionally, the start_delay may also be used to ramp up traffic and create the desired DI/DT, or transient, in the NoC 102. For example, after adjusting for the difference in arrival time of the trigger to each source node, the source nodes may be programmed to start up in a staggered sequence. For example, eight source nodes may be programmed to start generating and transmitting packets in the NoC 102 at time 0, eight more source nodes at time 10, and eight more source nodes at time 20, for example, until the last eight source nodes start up at time 90. According to aspects, this “ramp up” example may create a linear ramp of current with eight source nodes beginning to transmit packets in the NoC every 10 cycles. In some cases, one source node could be programmed to start every one cycle, spread out over 80 cycles, which still results in a linear ramp of current, but with smaller amounts of quantization per step and smaller steps. Further, in some cases, an exponential or quadratic ramp (in current consumption) could be achieved by changing the number of source nodes turning on and the time-delay offsets between them.

Similarly, according to aspects, the “stop_delay” value may be used to synchronize all data generators to stop sending packets at the same time or delayed to ramp down from the current traffic level. According to aspects, the stop_delay may be important for testing voltage overshoots in the PDN 114. According to aspects, the size of the counter and “start_delay” and “stop_delay” values may be dependent on the type of NoC architecture and may need to be large enough to cover the variation in when a broadcast message reaches each node and the slowest traffic ramp rate that needs to be generated.

Similarly, the aforementioned throttle delay values are also useful for testing voltage overshoots in the PDN 114 while still allowing packets to be sent in the NOC 102. In some cases, this can enable functional testing of hold (or other high voltage related circuit issues) during the overshoots.

As noted above, the data generator/comparator 302 may verify that packets are received correctly despite transients generated in the NoC 102 by a first plurality of packets generated according to one or more of the pre-defined patterns. For example, in some cases, as noted above, a first data generator/comparator 302 (e.g., corresponding to a source node) may transmit a first plurality of packets generated according to a pre-defined pattern in the NoC 102. According to aspects, transmitting the first plurality of packets in the NoC 102 may generate transients in the PDN 114 of the NoC 102. Thereafter, the first data generator/comparator 302 may transmit a second plurality of packets in the NoC 102 to a second data generator/comparator 302 (e.g., corresponding to a destination node). The destination node may verify that the packets transmitted by the source node are received correctly despite the transients generated in the NoC 102. According to aspects, for simplicity, all data being checked may be point to point (e.g., each destination will have only one source and each source will have only one destination). However, it should be noted that more-complex embodiments, such as broadcast traffic and other types of non-point-to-point traffic, may also be supported in the NoC 102.

According to aspects, in order to perform the verification on the received packets, the second data generator/comparator 302 corresponding to the destination node may be pre-programmed (e.g., in a data checking subfield of the CSR 304) to know what pattern of data to look for, which may eliminate the need to keep track of multiple streams of data and simplify design and verification. For example, in one example, the first data generator/comparator 302 may be configured to generate and transmit packets according to a first pre-defined pattern (e.g., “all-zeros”). In such a case, the second data generator/comparator 302 corresponding to the destination node may be pre-programmed to know that it should be receiving “all-zeros” packets from the first data generator/comparator 302. Therefore, after receiving the packets, the second data generator/comparator 302 corresponding to the destination node may verify that the packets contain all zeros. If the second data generator/comparator 302 corresponding to the destination node detects that any of the bits in the packets do not match the expected data, the second data generator/comparator 302 corresponding to the destination node may flag the error and the wire of the communication link 108 over which the incorrect data was received. In some cases, the second data generator/comparator 302 corresponding to the destination node may provide results of the verification of the packets to the first data generator/comparator 302 corresponding to the source node.

According to aspects, if an encoding scheme or low voltage swing is used, additional error reporting may be required. For example, it may be desirable to know not only that a failure occurred but exactly which bit or bits the failure occurred on. This helps with root-cause failure analysis, testing, design improvements and voltage/performance margining post-Silicon. For example, if an encoding scheme was in use, additional error reporting may be used to signal whether the packet that failed was one for which a complement wire (e.g., used for signaling inversions in transmitted bits) was used and also if the complement wire itself failed or if one or more bits that should have been inverted weren't inverted.

According to aspects, for aiding debugging in the NoC 102, a single bit error detected status indicator for each bit of the communication channel may be requested, for example, as configured in the CSR 304. According to aspects, if an error is found on a particular bit of the communication link 108 over which the packets are transmitted to the destination node, a data check status entry in the CSR 304 may be updated indicating the detected error and corresponding bit.

In some cases, the data generator/comparator 306 may include a counter configured to count the number of clock cycles with errors in the transmitted packets. According to aspects, if the counter reaches a pre-defined maximum, an indication may be provided to the NoC 102. Additionally, it should be noted that the first data generator/comparator 302 may provide enough bits/packets to the second data generator/comparator 302 so as to reliable compute a failure rate as a function of voltage, frequency, and runtime.

According to aspects, any errors detected in the received packets may be used in determining whether additional voltage margin supplied by the voltage regulator 110 is needed. For example, if any errors are detected in the received packets, the data generator/comparator 302 may be configured to slow down the frequency of packet transmission at a corresponding voltage supplied by the PDN 114 and/or increase the voltage to eliminate errors in packets transmitted in the NoC 102. In some cases, trends may be reversed for a-typical failure mechanisms and using techniques described above may allow for testing for correct behavior in the presence of both voltage droops and voltage overshoots.

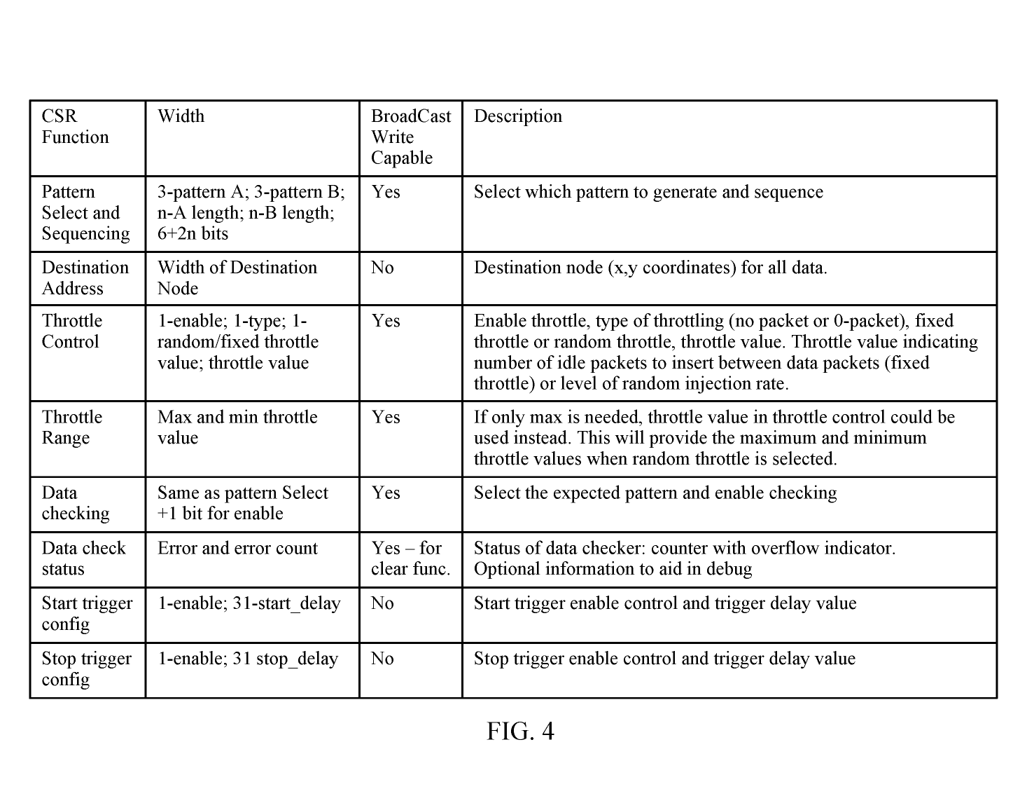

FIG. 4 is a table illustrating the various fields and information stored in the control status register of a data generator/comparator. According to aspects, the data generator/comparator (e.g., data generator/comparator 302) may use the information stored in the content status register (e.g., CSR 304) to determine how to generate packets to create transients in the NoC 102 and verify packets transmitted in the NoC despite the transients. In some cases, the information stored in the content status registers (used to control the data generator/comparators 302) may be programmed based on control signals received from a self-test engine (e.g., NoC self-test engine 116).

According to aspects, as illustrated, for generation and transmission of packets, the CSR 304 comprises an information field “pattern select and sequencing” that indicates to the data generator/comparator 302 which pre-defined patterns to use to generate packets and also the sequencing of pre-defined patterns to use. Additionally, the CSR 304 includes a “destination address” information field that indicates to the data generator/comparator 302 the address of the destination node (e.g., in x,y coordinates) to send the generated packets. Further, the CSR 304 includes a “throttle control” information field that indicates whether packet generation/transmission throttling is enabled, the type of throttling (e.g., no packet generation or “all-zeros” packet generation), and a fixed throttle or random throttle value. According to aspects, the throttle value indicates a number of idle packets (e.g., zeros or no packets/non-transmissions) to insert between data packets (e.g., for a fixed throttle) or a level of random packet injection rate (e.g., for a random throttle). Additionally, the CSR 304 includes a “throttle range” information field indicating a maximum and minimum throttle value to use to throttle packet generation/transmission, as described above. Additionally, the CSR 304 includes a “start trigger configuration” information field that indicates whether packet generation/transmission is enabled and also a trigger delay value that indicates how long the data generator/comparator 302 must wait, after receiving a start command, to start generating and transmitting packets in the NoC 102. Additionally, the CSR 304 includes a “stop trigger configuration” information field that indicates whether packet generation/transmission is disabled and also a trigger delay value that indicates how long the data generator/comparator 302 must wait, after receiving a stop command, to stop generating and transmitting packets in the NoC 102.

Further, for verification of received packets, the CSR 304 includes a “data checking” information field that indicates to the data generator/comparator 302 what data pattern to expect in the received packets and also and indicator indicating whether verification is enabled (e.g., whether the data generator/comparator 302 needs to perform verification of received packets). Additionally, the CSR 304 includes a “data check status” information field that indicates the status of the received packets (e.g., whether there are any errors in the received packets or if the received packets were received correctly). Additionally, in some cases, the “data check status” information field may include a counter that keeps track of the number of clock cycles with errors in the received packets and an overflow indicator if the counter reaches a maximum value.

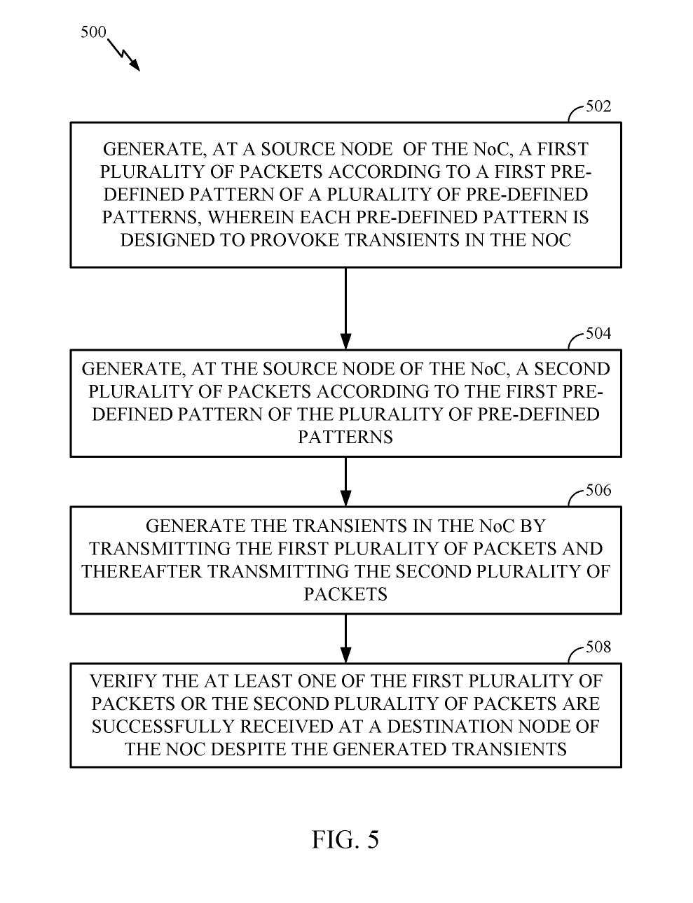

FIG. 5 illustrated example operations 500 for testing a network on chip (NoC). According to aspects, operations 500 may be performed by one or more apparatuses in the NoC, such as the self-test engine 116, one or more nodes 106, and/or one or more switches 104 (e.g., or the data generator/comparators 302 located within the switches 104).

Operations 500 begin at 502 by generating, at a source node of the NoC, a first plurality of packets according to a first pre-defined pattern of a plurality of pre-defined patterns, wherein each pre-defined pattern is designed to provoke transients in the NoC. At 504, the apparatus generates, at the source node of the NoC, a second plurality of packets according to the first pre-defined pattern of the plurality of pre-defined patterns. At 506, the apparatus generates the transients in the NoC by transmitting the first plurality of packets and thereafter transmitting the second plurality of packets. According to aspects, the transient may be generated in the NoC based on the transitions between the pluralities of packets transmitted in the NoC. At 508, the apparatus verifies at least one of the first plurality of packets or the second plurality of packets are successfully received at a destination node of the NoC despite the generated transients.

Operations 500 may be used to generate transients in the NoC 102 (e.g., in a PDN 114 of the NoC 102) used for evaluating the performance of the NoC 102. For example DI/DT events (e.g., transients) may be used to evaluate PDN 114 performance and DI/DT mitigation performance for both undershoot and overshoot scenarios at the voltage regulator 110. Additionally, the techniques presented herein may allow voltage droop detection hardware performance to be validated to the nanosecond resolution. Further, techniques presented herein may allow regional analog voltage sensors to be calibrated, for example, by creating controlled traffic in specific regions of the chip, as described above. Additionally, techniques presented herein may allow for testing on-die embedded voltage regulator circuits and response control loops.

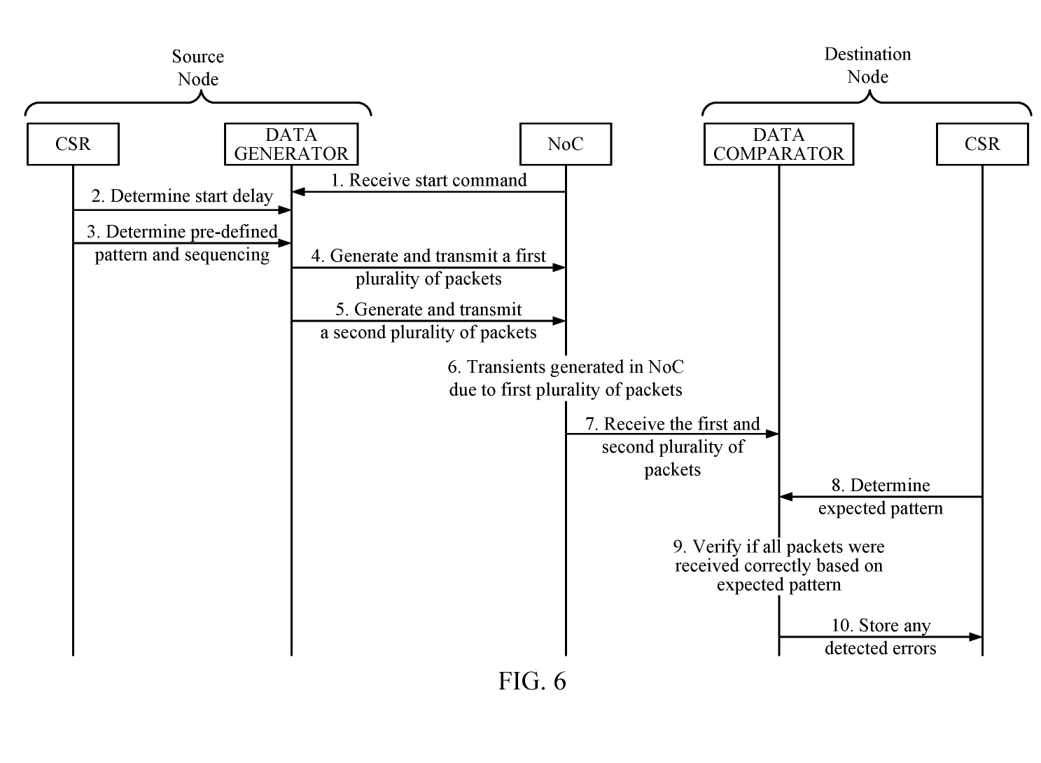

FIG. 6 is a call-flow diagram illustrating an example process for generating transients in a network on chip (NoC) and verifying packets are received correctly despite the transients, according to aspects presented herein. It should be noted that, while FIG. 6 illustrates specific steps for generating transients in an NoC, FIG. 6 may also include additional steps that are not listed but that are described herein, such as the techniques described above.

As illustrated, at step 1, a data generator (e.g., data generator/comparator 302) in the source node may receive a start command from the NoC (e.g., NoC 102), indicating to the data generator to begin generating and transmitting packets. In some cases, the start command may be broadcast in the NoC by a control module, such as a self-test engine (e.g., self-test engine 116) or may be received as a cross-trigger event stored in a cross-trigger matrix. After receiving the start command, at step 2, the data generator may determine a start delay associated with the start command (e.g., from information stored in content status register (CSR) (e.g., CSR 304) associated with the data generator) and wait a pre-defined amount of time before starting to generate and transmit packets.

At step 3, after (or during) the start delay, the data generator determines a pre-defined pattern to use to generate packets from information stored in the CSR. In some cases, the data generator may also determine a sequence of patterns to transmit. For example, in some cases, the CSR may indicate that the data generator is to generate and transmit packets according to a first pattern for a period of time and then generate and transmit packets according to a second pattern for a period of time.

At step 4, based on the determined pre-defined pattern and/or pattern sequence, the data generator may begin generating a first plurality of packets according to the pre-defined pattern and transmitting those packets in the NoC.

At step 5, based on the determined pre-defined pattern and/or pattern sequence, the data generator may begin generating a second plurality of packets according to the pre-defined pattern and transmitting those packets in the NoC. In some cases, the second plurality of packets may be generated according to a second (different) pre-defined pattern than that used to generate the first plurality of packets.

According to aspects, the transmission of the first plurality of packets and second plurality of packets may generate transients in the NoC (e.g., in a PDN of the NoC) pursuant to the pre-defined pattern used to generate the first plurality of packets and the second plurality of packets. As noted above, the data generator may generate and transmit packets according to a first pre-defined pattern for a first period of time and then begin transmitting packets generated according to the second pre-defined period for a second period of time.

Additionally, in some cases, the generation and transmission of the first plurality of packets and/or second plurality of packets may be throttled. For example, information stored in the CSR may indicate a rate (or a time in between packets) at which to transmit packets of the first plurality of packets/second plurality of packets. The information for throttle may also indicate a type of throttling to use. For example, in some cases, in between transmitting packets generated according to the pre-defined pattern, the information may indicate that the data generator is to transmit no packets or is to transmit “all-zero” packets, for example, as described above. Further, in some cases, the data generator may determine to generate transients only in a certain region of the NoC (e.g., as opposed to the entire NoC). In such a case, the data generator may receive information from the CSR indicating an address of a destination node of where to transmit the first plurality of packets/second plurality of packets. The data generator may then direct the first plurality of packets/second plurality of packets to the destination node, thereby generating the transients in the region of the NoC comprising the destination node.

According to aspects, and as noted above, at step 6, transients in the NoC (e.g., in a PDN of the NoC) may be generated in response to the transmission of the first plurality of packets and the second plurality of packets in the NoC (e.g., in response to the transition between transmitting the first plurality and the second plurality of packets).

At step 7, after traversing the NoC, the first plurality of packets and the second plurality of packets may be received at a data comparator of a destination node in the NoC.

At step 8, the data comparator in the destination node receives information from its corresponding CSR, indicating a type of data that is expected to be received. That is, the data comparator receives information indicating that the data comparator should be receiving packets generated according to a specific pre-define pattern.

At step 9, based on the expected data pattern, the data comparator verifies whether the first plurality of packets and/or the second plurality of packets were received correctly despite the transients generated in the NoC. In some cases, the data comparator may detect that certain bits (corresponding to certain wires in the communication link 108 over which these bits are transmitted) in the first plurality of packets and/or second plurality of packets were incorrectly received, for example, due to the transients in the NoC. Accordingly, at step 10, the data comparator may store information in the CSR indicating the incorrectly-received bits and their corresponding wires. Additionally, in some cases, the data comparator may keep track (e.g., in the CSR) of a number of cycles with incorrectly-received bits and provide an overflow indication when the number of cycles with incorrectly-received bits reaches a threshold amount, for example, as discussed above. In some cases, based on any errors detected in the first plurality of packets and/or the second plurality of packets, the NoC may be configured to slow down the frequency of packet transmission at a corresponding voltage supplied to the NoC and/or increase the voltage to eliminate errors in transmitted packets.

In some configurations, the term(s) ‘communicate,’ communicating; and/or ‘communication’ may refer to ‘receive,’ ‘receiving,’ ‘reception,’ and/or other related or suitable aspects without necessarily deviating from the scope of the present disclosure. In some configurations, the term(s) ‘communicate,’ ‘communicating,’ ‘communication,’ may refer to ‘transmit,’ ‘transmitting,’ ‘transmission’; and/or other related or suitable aspects without necessarily deviating from the scope of the present disclosure.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits.

One or more of the components, steps, features and/or functions illustrated herein may be rearranged and/or combined into a single component, step, feature or function or embodied in several components, steps, or functions. Additional elements, components, steps, and/or functions may also be added without departing from novel features disclosed herein. The apparatus, devices, and/or components illustrated herein may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

These apparatus and methods described in the detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, PCM (phase change memory), flash memory, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

What is claimed is:

1. A method for testing a network on chip (NoC), comprising:
generating, at a source node of the NoC, a first plurality of packets according to a first pre-defined pattern of a plurality of pre-defined patterns, wherein each pre-defined pattern is designed to provoke transients in the NoC;
generating, at the source node of the NoC, a second plurality of packets according to the first pre-defined pattern of the plurality of pre-defined patterns;
generating the transients in the NoC by transmitting the first plurality of packets and thereafter transmitting the second plurality of packets;
verifying at least one of the first plurality of packets or the second plurality of packets are successfully received at a destination node of the NoC despite the generated transients.

2. The method of claim 1, wherein the transients are generated in the NoC based on a transition between the transmission of a first plurality of packets and the transmission of the second plurality of packets.

3. The method of claim 1, wherein the second plurality of packets comprise a first number of bits indicating that the second plurality of packets comprise synthetic data generated for testing the NoC.

4. The method of claim 1, wherein the destination node is pre-programmed to know bits of data to expect in the second plurality of packets.

5. The method of claim 3, wherein verifying the second plurality of packets are successfully received comprises comparing bits of data expected in the second plurality of packets to bits of data received in the second plurality of packets.

6. The method of claim 1, further comprising:
modulating a magnitude of the transients, wherein modulating the magnitude of the transients comprises transmitting a third plurality of packets generated according to a second pre-defined pattern designed to provoke a different transient than the first pre-defined pattern.

7. The method of claim 5, wherein modulating the magnitude of the transients further comprises varying a length of time after which packets, generated according to different pre-defined patterns, are transmitted on the NoC.

8. The method of claim 1, wherein the first pre-defined pattern comprises one of:
setting all data bits in at least one of the first plurality of packets or the second plurality of packets to zero;
setting all data bits in at least one of the first plurality of packets or the second plurality of packets to ones;
alternating, between clock cycles of the NoC, setting data bits in the first plurality of packets and the second plurality of packets between ones and zeros;
alternating, between clock cycles of the NoC, setting nibbles of data bits in the first plurality of packets and the second plurality of packets between 0xA and 0x5;
setting data bits in the first plurality of packets and the second plurality of packets according to a pseudo-random binary sequence; or
setting data bits in the first plurality of packets and the second plurality of packets according to a virus data pattern designed to maximize toggling in a bus line of the NoC and power consumed by the NoC.

9. The method of claim 8, wherein the pre-defined patterns are designed to stress resonance frequency of a power delivery network (PDN) supplying power to the NoC.

10. The method of claim 8, wherein generating and transmitting the first plurality of packets and the second plurality of packets is each performed according to a respective rate.

11. The method of claim 10, wherein the pre-defined patterns are designed to stimulate and test stability of on-die analog and digital sensors employed in the NoC, wherein analog and digital sensors comprise any of current meters, embedded voltage regulators, or control loops.

12. The method of claim 1, wherein each pre-defined pattern is associated with a different count indicating a maximum number of times that data packets generated according to that pre-defined pattern may be sequentially transmitted in the NoC;

13. The method of claim 12, further comprising:
repeating the generating and transmitting of the first plurality of packets and second plurality of packets until the count associated with the first pre-defined pattern has been reached; and
after the count for the first pre-defined pattern has been reached:
generating a third plurality of packets according to a second pre-defined pattern of a plurality of pre-defined patterns different from the first pre-defined pattern; and
transmitting the third plurality of packets in the NoC, wherein generating and transmitting the third plurality of packets is repeated until a count associated with the second pre-defined pattern has been reached.

14. The method of claim 13, wherein transmitting the third plurality of packets generates a different transient in the NoC than the first pre-defined pattern.

15. The method of claim 1, further comprising evaluating performance of a power delivery network (PDN) delivering power to the NoC in presence of the generated transients.

16. The method of claim 15, wherein evaluating comprising evaluating transient mitigation performance in the PDN for at least one of undershoot or overshoot scenarios generated by a voltage regulator in the PDN.

17. The method of claim 1, wherein generating the transients comprises generating the transients in only a first region of the NoC, wherein the first region of the NoC comprises a first number of nodes in the NoC and excludes a second number of nodes in the NoC.

18. The method of claim 17, wherein generating the transients in only a first region of the NoC comprises directing the transmission of the first plurality of packets and the second plurality of packets to the first region of the NoC.

19. The method of claim 17, further comprising evaluating performance of at least a section of a power delivery network (PDN) corresponding to the first region.

20. The method of claim 1, wherein generating and transmitting the first plurality of packets and second plurality of packets is based on first receiving a start command broadcast in the NoC.

21. The method of claim 20, further comprising, after receiving the start command, waiting a pre-programmed start delay before starting to generate and transmit the first plurality of packets and the second plurality of packets.

22. The method of claim 1, further comprising:
receiving a stop command broadcast in the NoC; and
stopping the generation and transmission of the first plurality of packets and second plurality of packets based on the stop command, wherein the generation and transmission of the first plurality of packets is stopped after a pre-programmed stop delay.

23. A circuit comprising:
means for generating, at a source node of the NoC, a first plurality of packets according to a first pre-defined pattern of a plurality of pre-defined patterns, wherein each pre-defined pattern is designed to provoke transients in the NoC;
means for generating, at the source node of the NoC, a second plurality of packets according to the first pre-defined pattern of the plurality of pre-defined patterns;
means for generating the transients in the NoC by transmitting the first plurality of packets and thereafter transmitting the second plurality of packets; and
means for verifying at least one of the first plurality of packets or the second plurality of packets are successfully received at a destination node of the NoC despite the generated transients.

24. The circuit of claim 23, wherein the transients are generated in the NoC based on a transition between the transmission of a first plurality of packets and the transmission of the second plurality of packets.

25. The circuit of claim 23, wherein the first pre-defined pattern comprises one of:
setting all data bits in at least one of the first plurality of packets or the second plurality of packets to zero;
setting all data bits in at least one of the first plurality of packets or the second plurality of packets to ones;
alternating, between clock cycles of the NoC, setting data bits in the first plurality of packets and the second plurality of packets between ones and zeros;
alternating, between clock cycles of the NoC, setting nibbles of data bits in the first plurality of packets and the second plurality of packets between 0xA and 0x5;
setting data bits in the first plurality of packets and the second plurality of packets according to a pseudo-random binary sequence; or
setting data bits in the first plurality of packets and the second plurality of packets according to a virus data pattern designed to maximize toggling in a bus line of the NoC and power consumed by the NoC.

26. A computer readable medium having instructions stored thereon for causing a circuit to perform a method of calibrating a component, the method comprising:
generating, at a source node of the NoC, a first plurality of packets according to a first pre-defined pattern of a plurality of pre-defined patterns, wherein each pre-defined pattern is designed to provoke transients in the NoC;
generating, at the source node of the NoC, a second plurality of packets according to the first pre-defined pattern of the plurality of pre-defined patterns;
generating the transients in the NoC by transmitting the first plurality of packets and thereafter transmitting the second plurality of packets; and
verifying at least one of the first plurality of packets or the second plurality of packets are successfully received at a destination node of the NoC despite the generated transients.

27. The computer readable medium of claim 26, wherein the transients are generated in the NoC based on a transition between the transmission of a first plurality of packets and the transmission of the second plurality of packets.

28. The computer readable medium of claim 26, wherein the first pre-defined pattern comprises one of:
setting all data bits in at least one of the first plurality of packets or the second plurality of packets to zero;
setting all data bits in at least one of the first plurality of packets or the second plurality of packets to ones;
alternating, between clock cycles of the NoC, setting data bits in the first plurality of packets and the second plurality of packets between ones and zeros;
alternating, between clock cycles of the NoC, setting nibbles of data bits in the first plurality of packets and the second plurality of packets between 0xA and 0x5;
setting data bits in the first plurality of packets and the second plurality of packets according to a pseudo-random binary sequence; or
setting data bits in the first plurality of packets and the second plurality of packets according to a virus data pattern designed to maximize toggling in a bus line of the NoC and power consumed by the NoC.

29. A circuit comprising:
a network on chip (NoC), configured to:
generate, at a source node of the NoC, a first plurality of packets according to a first pre-defined pattern of a plurality of pre-defined patterns, wherein each pre-defined pattern is designed to provoke transients in the NoC;
generate, at the source node of the NoC, a second plurality of packets according to the first pre-defined pattern of the plurality of pre-defined patterns;
generate the transients in the NoC by transmitting the first plurality of packets and thereafter transmitting the second plurality of packets; and
verify at least one of the first plurality of packets or the second plurality of packets are successfully received at a destination node of the NoC despite the generated transients.

30. The circuit of claim 29, wherein the first pre-defined pattern comprises one of:
setting all data bits in at least one of the first plurality of packets or the second plurality of packets to zero;
setting all data bits in at least one of the first plurality of packets or the second plurality of packets to ones;
alternating, between clock cycles of the NoC, setting data bits in the first plurality of packets and the second plurality of packets between ones and zeros;
alternating, between clock cycles of the NoC, setting nibbles of data bits in the first plurality of packets and the second plurality of packets between 0xA and 0x5;
setting data bits in the first plurality of packets and the second plurality of packets according to a pseudo-random binary sequence; or
setting data bits in the first plurality of packets and the second plurality of packets according to a virus data pattern designed to maximize toggling in a bus line of the NoC and power consumed by the NoC.
